(19) United States
(12) Patent Application Publication
(10) Pub. No.: US 2024/0095661 A1
(43) Pub. Date: Mar. 21, 2024

(54) SYSTEM AND METHOD FOR MANAGING INVENTORY FOR ELECTRONIC RAFFLE

(71) Applicant: Hibbett Retail, Inc., Birmingham, AL (US)

(72) Inventors: Christopher Lee Blair, Pelham, AL (US); Jerrel Devan Cooley, Sterrett, AL (US); David Alan Stachowiak, JR., Denton, TX (US); Ryan Christian Besterwitch, Denton, TX (US); Kevin Leung Young, Chandler, AZ (US)

(73) Assignee: Hibbett Retail, Inc., Birmingham, AL (US)

(21) Appl. No.: 17/945,545

(22) Filed: Sep. 15, 2022

(51) Int. Cl. G06Q 10/08; G06Q 30/02

(52) U.S. Cl. CPC G06Q 10/087; G06Q 30/0212

(57) ABSTRACT

A system and method for managing inventory for an electronic raffle is provided. The system may include an inventory database to store inventory data for one or more items to be sold via the electronic raffle, wherein the inventory data includes in-store inventory data and online inventory data, a mobile application configured to generate a raffle entry for the one or more items, a raffle database configured to store the inventory data and one or more raffle entries, and a middleware server configured to update the in-store inventory data stored in the raffle database based on the updated in-store inventory data obtained from the inventory database. The middleware server selects a first round winning raffle entry, transmits a notification to the mobile device associated with the first round winning raffle entry, and initiates a payment process upon determining that the first round winning raffle entry applies to the lightning round.

### TECHNICAL FIELD

Example embodiments of the present disclosure generally relate to inventory management systems, and more specifically relate to inventory management systems associated with electronic raffles.

### BACKGROUND

Retailers have traditionally conducted raffle contests for various merchandise items, in which customers submit raffle entries and the retailer randomly selects a winning raffle entry. The customer who submitted the winning raffle entry may be present at the time the winning raffle entry is selected to take possession of the item, or the retailer may contact the customer to retrieve the item.

Traditional raffle contests have since evolved and now allow customers to submit electronic raffle entries via computer networks, such as the Internet. Winners can be randomly selected and notified of their selection via email, text message, or the like, and the item may be picked up by the winner at a brick and mortar location or may be shipped directly to a customer. While such electronic raffles may provide added conveniences with respect to receiving raffle entries and notifying winners, inventory management is challenging especially when there are multiple raffles for multiple items having multiple varieties and/or sizes, the items may be shipped or picked up at multiple locations, and multiple payment options are available for raffle items that must be purchased.

For example, certain athletic shoes have become in such high demand that customers diligently monitor the date on which they will become available for purchase, and may even wait outside a retailer's store for hours or days beforehand. These situations sometimes lead to altercations between customers trying to purchase the same pair of shoes, such that electronic or online raffles have been used in order to randomly select which customers will have the first option to purchase the shoes. However, these online raffles often suffer from inventory managements problems such as notifying a customer that they have won the raffle to purchase a pair of shoes, only to find out when they arrive at the store to pick up the shoes that the shoes are at a different location, were inadvertently sold to an in-store customer, or multiple raffle winners were selected for the same pair of shoes. These problems are compounded for retailers that have multiple locations spread across a wide geographic area. In addition, electronic raffles may be susceptible to ‘bots’ or automated software applications that submit multiple raffle entries on behalf of the same person in order to unfairly increase that person's chances of winning. Accordingly, there is a need for an improved inventory management system for electronic raffles that may address one or more of these problems.

### SUMMARY

According to an aspect of one or more example embodiments, there is provided an inventory management system for managing inventory for an electronic raffle. The inventory management system may include an inventory database configured to store inventory data for one or more items to be sold via the electronic raffle, wherein the inventory data may include in-store inventory data relating to the one or more items to be picked up in-store by a winner of the electronic raffle, and online inventory data relating to online inventory of the one or more items to be shipped to a winner of said electronic raffle, a mobile application configured to execute on a mobile device and generate a raffle entry for the one or more items, wherein the raffle entry includes bibliographic information of a user, size information for the one or more items, store raffle information indicating whether the raffle entry applies to in-store inventory and identifying one more stores at which said one or more items may be picked up, online raffle information indicating whether the raffle entry applies to online inventory, and lightning round information indicating whether the raffle entry applies to a lightning round of the electronic raffle, a raffle database configured to store one or more raffle entries for said one or more items, and the inventory data, a middleware server configured to determine whether the in-store inventory data stored in the raffle database has been confirmed, and in response to determining that the in-store inventory data stored in the raffle database has not been confirmed, obtaining updated in-store inventory data from the inventory database, and updating the in-store inventory data stored in the raffle database based on the updated in-store inventory data obtained from the inventory database. The middleware server may be configured to select a first round winning raffle entry from the one or more raffle entries stored in the raffle database, transmit a notification to the mobile device associated with the first round winning raffle entry, and initiate a payment process upon determining that the first round winning raffle entry applies to the lightning round.

Upon determining that the first round winning raffle entry does not apply to the lightning round, and is rejected or not confirmed, the middleware server is configured to select a second round winning raffle entry from said one or more raffle entries stored in the raffle database, transmit a notification to the mobile application of the mobile device associated with the second round winning raffle entry, and initiate a payment process upon determining that the second round winning raffle entry applies to the lightning round.

Upon determining that the second winning raffle entry does not apply to the lightning round, and is rejected or not confirmed, the middleware server is configured to select a lightning round winning raffle entry from the one or more raffle entries stored in the raffle database having lightning round information indicating that the one or more raffle entries applies to the lightning round, transmit a notification to the mobile application of the mobile device associated with the lightning round winning raffle entry, and initiate a payment process.

The middleware server may select the first round winning raffle entry based on a comparison of the size information included in the raffle entry and size information of said one or more items to be sold via the electronic raffle. The middleware server may select the first round winning raffle entry based on a comparison of store raffle information identifying one or more stores at which said one or more items may be picked up, and in-store inventory data indicating the one or more items to be sold via the electronic raffle is located at the one or more stores identified by the store raffle information. The notification transmitted by the middleware server to the mobile application includes a location from which said user can pick up said one or more items. The middleware server may select the first round winning raffle entry based on a comparison of online raffle information indicating that a raffle entry applies to online inventory, and online inventory data indicating that said one or more items to be sold via the electronic raffle are in online inventory.

The middleware server may determine whether the lightning round information indicates that the raffle entry applies to the lightning round, and selects the first round winning raffle entry of said one more items in online inventory based on determining that the winning raffle entry applies to the lightning round. The middleware server is configured to generate a shipping order to ship said one or more items in online inventory to the user based on said bibliographic information of the user. Upon determining that the first round winning raffle entry is rejected or not confirmed, the middleware server may be configured to remove the first round winning raffle entry from the raffle database before selecting the second round winning raffle entry. The in-store inventory data stored in the inventory database indicates an expected number of said one or more items available at a particular store. The raffle database may be configured to receive confirmation of an actual number of said one or more items available at the particular store, and the middleware server is configured to update the inventory data stored in the raffle database based on said confirmation. The inventory data stored in the inventory database and the raffle database may be updated based on the selection of the first round winning raffle entry. The raffle entry may include a phone number and device ID associated with the mobile device, and an email address associated with the raffle entry. The middleware server may be configured to validate said email address and said phone number, determine whether any other raffle entries for said one or more items have been received, reject said raffle entry if the middleware server is unable to validate said email address or said phone number, and reject said raffle entry if said phone number, device ID, or email address is associated with said any other raffle entries.

According to one or more example embodiments, there is provided a method of managing inventory for an electronic raffle using an inventory management system. The method may include storing inventory data for one or more items to be sold via the electronic raffle in an inventory database of the management system, wherein the inventory data comprises in-store inventory data relating to the one or more items to be picked up in-store by a winner of the electronic raffle, and online inventory data relating to online inventory of the one or more items to be shipped to a winner of said electronic raffle, generating a raffle entry for the one or more items, wherein the raffle entry includes bibliographic information of a user, size information for said one or more items, store raffle information indicating whether the raffle entry applies to in-store inventory and identifying one more stores at which the one or more items may be picked up, online raffle information indicating whether the raffle entry applies to online inventory, and lightning round information indicating whether the raffle entry applies to a lightning round of the electronic raffle, storing the inventory data and one or more raffle entries for the one or more items in a raffle database, determining whether the in-store inventory data stored in the raffle database has been confirmed, and in response to determining that the in-store inventory data stored in the raffle database has not been confirmed, obtaining updated in-store inventory data from the inventory database, and updating the in-store inventory data stored in the raffle database based on the updated in-store inventory data obtained from the inventory database, selecting a first round winning raffle entry from said one or more raffle entries stored in the raffle database, transmitting a notification to a mobile device associated with the first round winning raffle entry, and initiating a payment process upon determining that the first round winning raffle entry applies to the lightning round.

The method may include determining that the first round winning raffle entry does not apply to the lightning round, and is rejected or not confirmed, selecting a second round winning raffle entry from the one or more raffle entries stored in the raffle database, transmitting a notification to the mobile application of a mobile device associated with the second round winning raffle entry, and initiating a payment process upon determining that the second round winning raffle entry applies to the lightning round.

The method may include determining that the second winning raffle entry does not apply to the lightning round, and is rejected or not confirmed, selecting a lightning round winning raffle entry from said one or more raffle entries stored in the raffle database having lightning round information indicating that the one or more raffle entries applies to the lightning round, transmitting a notification to the mobile application of the mobile device associated with the lightning round winning raffle entry, and initiating a payment process.

The first round winning raffle entry may be selected based on a comparison of the size information included in the raffle entry and size information of said one or more items to be sold via the electronic raffle. The first round winning raffle entry may be selected based on a comparison of store raffle information identifying one or more stores at which the one or more items may be picked up, and in-store inventory data indicating the one or more items to be sold via the electronic raffle is located at said one or more stores identified by the store raffle information. The in-store inventory data stored in the inventory database may indicate an expected number of said one or more items available at a particular store. The method may include receiving, at the raffle database, confirmation of an actual number of said one or more items available at the particular store, and updating the inventory data stored in the raffle database based on said confirmation.

The raffle entry may raffle entry include a phone number and device ID associated with a mobile device associated with the user, and an email address associated with the raffle entry. The method may include validating said email address and said phone number, determining whether any other raffle entries for the one or more items have been received, rejecting the raffle entry if the middleware server is unable to validate said email address or the phone number, and rejecting said raffle entry if said phone number, device ID, or email address is associated with said any other raffle entries.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates a block diagram of an inventory management system for electronic raffles according to various example embodiments.

FIG. 2 illustrates an example of a mobile application receiving information from a user and generating a raffle entry according to various example embodiments.

FIG. 3 illustrates a process for detecting and rejecting duplicate raffle entries from the same participant, or raffle entries that appear suspicious, according to various example embodiments.

FIG. 4 illustrates an example of the raffle database and the inventory database according to various example embodiments.

FIG. 5 illustrates a method of managing inventory for conducting an electronic raffle according to various example embodiments.

FIGS. 6A and 6B illustrate a flow chart of an electronic raffle using an inventory management system according to various example embodiments.

FIGS. 7A through 7G illustrate a series of screenshots of the mobile application allowing the user to enter an electronic raffle using an inventory management system according to various example embodiments.

### DETAILED DESCRIPTION OF EXAMPLE EMBODIMENTS

Reference will now be made in detail to the following various examples, which are illustrated in the accompanying drawings, wherein like reference numerals refer to like elements throughout. The following examples may be embodied in various forms without being limited to the examples set forth herein.

This description of the example embodiments is intended to be read in connection with the accompanying drawings, which are to be considered part of the entire written description. The use of the singular includes the plural unless specifically stated otherwise. As used in the specification, the singular forms “a,” “an” and “the” include plural referents unless the context clearly dictates otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Moreover, certain elements or components may be described herein as separate elements or components that perform certain functions, however, such elements or components may be combined or such functions may be performed by other elements or components, unless specifically stated otherwise. Additionally, the section headings used herein are for organizational purposes only, and are not to be construed as limiting the subject matter described.

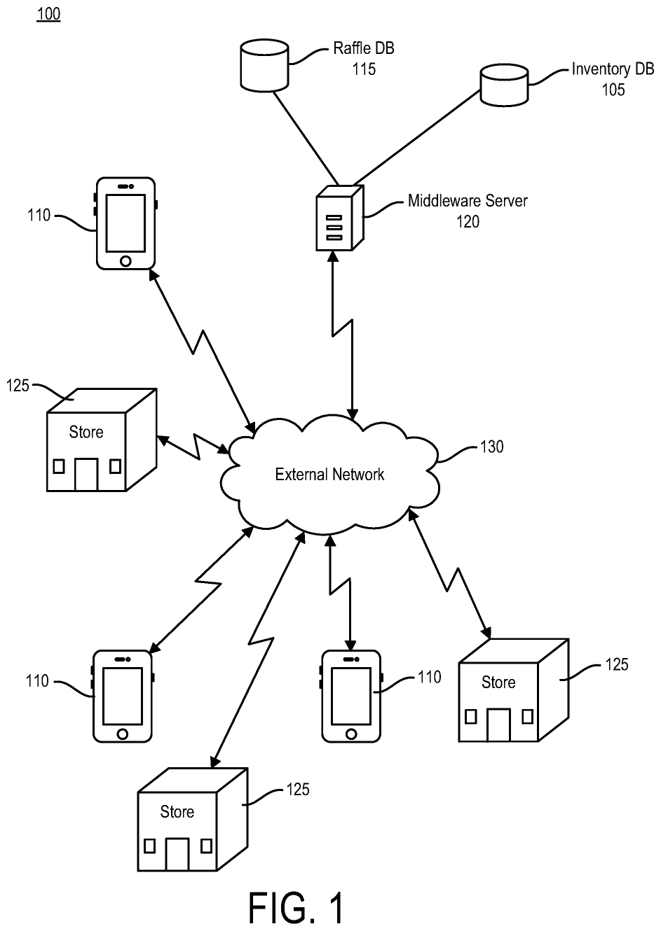

FIG. 1 illustrates a block diagram of an inventory management system 100 for electronic raffles according to various example embodiments. Referring to FIG. 1, the inventory management system 100 may include an inventory database 105 configured to store inventory data, a mobile application 110 configured to run on a plurality of users' cellular phones, tablets, mobile devices, etc., and configured to receive raffle entry information and generate a raffle entry based on the raffle entry information, a raffle database 115 configured to store a plurality of raffle entries, a middleware server 120 configured to select winning raffle entries, and a plurality of store terminals 125, which may be used to confirm inventory for the raffle database 115, and which are respectively located at a plurality of retail stores that sell the items to be electronically raffled. The various components of the example inventory management system 100 may communicate using an external network 130 (e.g., the Internet). Alternatively, the various components of the inventory management system 100 may communicate via other wired or wireless connections, and may support various communications protocols (e.g., WIFI, Bluetooth, cellular, etc.).

A user may download and install the mobile application 110 onto the user's mobile device, tablet, cellular phone, etc., and may request to enter an electronic raffle for a particular item via the mobile application 110. The mobile application 110 may provide a list of items available via the electronic raffle for the user to view, and may provide information regarding each items, such as a photograph, manufacturing and material information, size information and the like. While displaying information about the particular item available via the electronic raffle, the mobile application 110 may allow the user to generate a raffle entry for the item. Alternatively, the mobile application 110 may allow the user to begin generating a raffle entry and subsequently identify the item or items for which the user would like to submit a raffle entry.

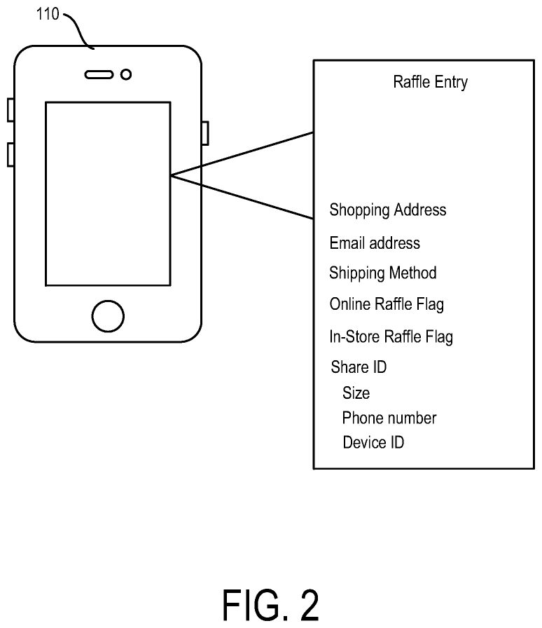

FIG. 2 illustrates an example of a mobile application 110 receiving information from a user and generating a raffle entry according to various example embodiments. Referring to FIG. 2, according to various example embodiments, the mobile application 110, upon receiving a request from the user to initiate a raffle entry, is configured to receive information from user, which may include one or more of: a shipping address, a billing address, a preferred shipping method, a payment method, payment information, user bibliographic information such as the user's name and email address, size information for the raffle item, store raffle information indicating whether the raffle entry applies to in-store inventory and if so indicating one or more stores for picking up the raffled item, online raffle information indicating whether the raffle entry applies to online inventory, and lightning round information indicating whether the raffle entry applies to a lightning round. The raffle entry may also include a device ID corresponding to the user's device, which may be obtained by the mobile application 110 from software operating on the user's mobile device. The electronic raffle may select winning entries, as discussed in more detail below, based on whether an item is located at a particular store or if an items is located, for example, at a warehouse that is used for fulfilling online orders. The store raffle information and online raffle information provided by the user indicate whether the raffle entry applies to one or both of items found in in-store inventory and items located in online inventory.

As referenced above, electronic raffles that allow raffle entries to be submitted electronically, for example via the Internet, can be susceptible to abuse by participants attempting to increase their chances of winning. For example, participants may try to submit multiple raffle entries using the same email address or same mobile device, or may submit multiple entries under fake email addresses to create the appearance that the entries are from different participants. Participants submit multiple entries under multiple voice over IP (VOIP) numbers to create the appearance that the entries are submitted by different participants. In order to ensure a more fair electronic raffle, the inventory management system 100 according to various example embodiments may conduct a process for identifying and rejecting multiple raffle entries from the same user.

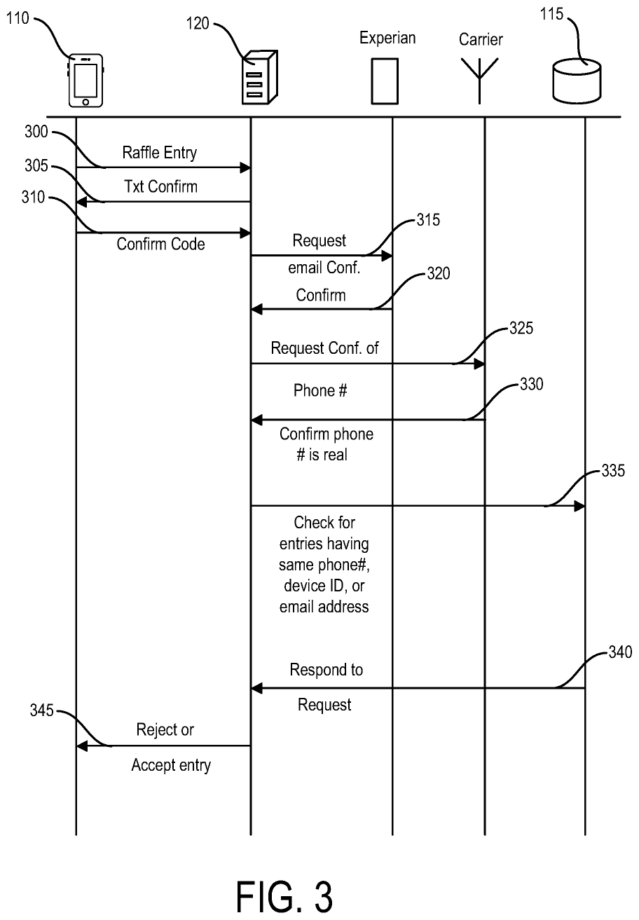

FIG. 3 illustrates a process for detecting and rejecting duplicate raffle entries from the same participant, or raffle entries that appear suspicious, according to various example embodiments. FIG. 3 illustrates multiple messages transmitted between various components, which one of ordinary skill in the art would understand includes direct transmissions between components or indirect transmissions via intervening components that may not be shown in FIG. 3. Referring to FIG. 3, once the mobile application 110 receives the raffle entry information from the user, at step 300 the mobile application 110 transmits the entry to the middleware server 120. The middleware server 120 may include a processor and a memory configured to receive the raffle entry from the mobile application and identify the raffle entry information contained within the raffle entry. In step 305, the middleware server 120 may cause a text message or other authenticating message containing a password or code to be transmitted to the mobile device upon which the mobile application 110 is running. The text message or other authenticating message may request the user to enter the code or password through the mobile application 110 in order to authenticate the user who submitted the raffle entry. The mobile application 110 may allow the user to input the code or password provided in step 305, and in step 310 transmit the code or password input by the user to the middleware server 120, which confirms that the code or password provided by the user matches the code or password provided in step 305. If the user-provided code or password received by the middleware server 120 in step 310 does not match the code or password provided in step 305, the middleware server 120 may cause a message to be transmitted to the mobile application 110 indicating that the raffle entry has been rejected. Alternatively, the middleware server 120 may transmit a notification to the mobile application requesting re-submission of the code or password, and verify that a subsequently transmitted code or password matches the code or password provided in step 305.

In step 315, the middleware server 120 may transmit a request to a service for authenticating the email address associated with the raffle entry. For example, Experian provides a service by which an email server associated with the domain of the email address provided is pinged to determine whether the provided email address exists. In step 320, an email confirmation message is transmitted back to the middleware server 120 indicating whether the email address provided with the raffle entry exists. If the email confirmation message indicates that the email address does not exist, the middleware server 120 may cause a message to be transmitted to the mobile application 110 indicating that the raffle entry has been rejected.

The middleware server 120 may also confirm that the phone number associated with the raffle entry is legitimate. For example, voice-over IP (VoIP) phone numbers may be configured to respond to authentication request such as the authentication request transmitted in step 305 to create the appearance that a raffle entry associated with the VoIP number is submitted by a different participant than may have submitted a previous raffle entry using a different cellular phone number. To address this problem, the middleware server 120, in step 325, may transmit a request containing the phone number associated with the raffle entry to one or more servers of one or more approved cellular carriers to verify that the phone number is associated with a customer of one of the approved cellular carriers. In step 330, the cellular carrier server(s) may transmit a confirmation message back to the middleware server 120 indicating whether the phone number provided in step 325 corresponds to a phone number associated with a customer of one of the approved cellular carriers. If the confirmation message transmitted in step 330 does not indicate that the phone number provided with the raffle entry corresponds to a phone number associated with a customer of one of the approved cellular carriers, the middleware server 120 reject the raffle entry, and cause the mobile application 110 to display a message indicating the raffle entry rejection to the user.

In step 335, the middleware server 120 may transmit a request to the raffle database 115 to confirm that the same participant has not submitted multiple raffle entries for the same raffle item. For example, the request transmitted in step 335 may include the phone number, device ID, and/or email address associated with the received raffle entry, or may transmit the raffle entry itself. The raffle database 115 may receive the request and verify whether any previously received raffle entries contain the same phone number, device ID, and/or email address that were submitted in step 335. In step 340, the raffle database 115 may transmit a response to the middleware server 120 indicating whether any previously submitted raffle entries stored in the raffle database 115 include a phone number, device ID, and/or email address that match the phone number, device ID, and/or email address provided in step 335. If the response transmitted in step 340 indicates that a previously submitted raffle entry stored in the raffle database 115 includes a phone number, device ID, and/or email address that matches the phone number, device ID, and/or email address provided in step 335, in step 345 the middleware server 120 may transmit a rejection message to the mobile application 110 indicating that the raffle entry has been rejected.

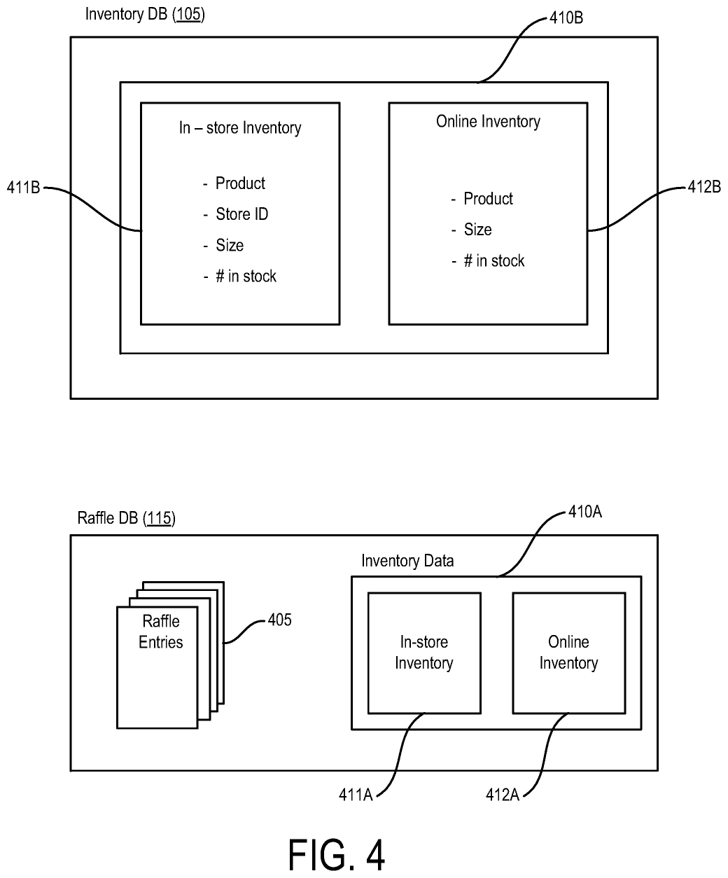

Once a raffle entry has been accepted by the middleware server 120, the middleware server 120 may transmit the raffle entry to the raffle database 115, which stores the raffle entries that have been accepted by the middleware server 120. FIG. 4 illustrates an example of the raffle database 115 and the inventory database 105 according to various example embodiments. The raffle database 115 may be configured to store a plurality of raffle entries 405 that it receives from the middleware server 120. The raffle database 115 may be configured to also store inventory data 410A, which may include in-store inventory data 411A and online inventory data 412A. The inventory database 105 may also store inventory data 410B, which may be based on an expected amount of inventory. For example, a retailer may have ordered a certain number of items from a manufacturer or distributor, and the inventory data 410B stored in the inventory database 105 may reflect the number, size, etc. of the ordered items. The in-store inventory data 411B stored in the inventory database 105 may be based on the number, size, etc. of each item that the retailer expects to be available at each physical retail location, whereas the online inventory data 412B may reflect the number, size, etc. of each item that the retailer expects to use to fulfill online orders. The middleware server 120 may obtain the inventory data 410B from the inventory database 105 and store it as inventory data 410A in the raffle database 115 for use in the electronic raffle. As sales are made, via in-store purchases, online purchases that are dropped shipped to the customer, or buy-online-pickup-in-store (BOPIS) purchases, the middleware server 120 may update the inventory data 410B of the inventory database 105 to indicate that the sold items are no longer inventory.

When the physical retail locations actually receive items from the manufacturer or distributor, the actually received inventory may or may not match the expected inventory data 410B stored in the inventory database 105. For example, the manufacturer or distributor may ship the wrong size of a particular item, may ship certain items to a different physical retail location than what was intended, or some items may be damaged, and therefore unable to be sold to customers at the retail location. In each of these instances, the inventory data 410B stored in the inventory database 105 and the raffle database 115 may not match the actual in-store or online inventory, which when conducting an electronic raffle may result in notifying raffle winners that they have won an item that is not available. Store terminals 125 may be configured to update the inventory data 410B/410A stored in the inventory database 105 and/or the raffle database 115 based on the actually received inventory. For example, the store terminals 125 may be configured to read bar codes, QR codes, RFID tags, and the like to identify items that are received at physical retail locations. The store terminals 125 may be configured to then update the inventory database 105 and/or the raffle database 115 based on the identified items. The store terminals 125 may communicate with the inventory database 105 and/or the raffle database 115 directly or via the middleware server 120 using a communications network (e.g., the Internet) in order to update the inventory data 410B/410A.

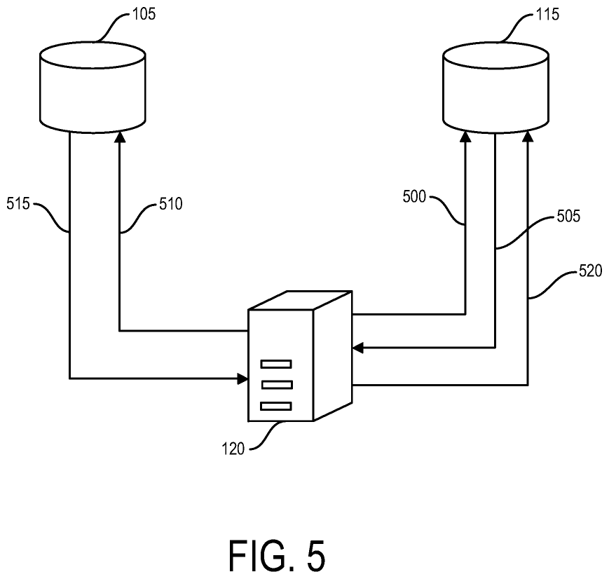

FIG. 5 illustrates a method of managing inventory for conducting an electronic raffle according to various example embodiments. Referring to FIG. 5, prior to the beginning of an electronic raffle, in step 500 the middleware server 120 may query the raffle database 115 to determine if the inventory data 410A stored in the raffle database 115 has been confirmed, or been confirmed within a predetermined time period. For example, the middleware server 120 may request whether the in-store inventory data 411A has been confirmed for a particular in-store location, or request a list of in-store locations that have or have not had their inventories confirmed. In addition, the middleware server 120 may query the raffle database 115 to determine whether the online inventory data 412A has been confirmed. In step 505, the raffle database 115 responds to the query received in step 500, indicating to the middleware server 120 which physical in-store locations have confirmed their inventory, and/or whether the online inventory data 412A has been confirmed. The raffle database 115 may also indicate the date and time at which the inventory data 410A stored in the raffle database 115 was last updated or confirmed. According to an example embodiment, by only responding with data that has not been confirmed, the amount of data transmitted between the raffle database 115 and the middleware server 120 may be reduced, which may allow the inventory management system to manage inventory faster and more efficiently.

In step 510, the middleware server 120 queries the inventory database 105 for inventory data 410B for in-store inventory data 411B and online inventory data 412B that has not been confirmed. For example, if only a small number of physical in-store locations have not confirmed their in-store inventory data 411B, in step 510 the middleware server 120 may request in-store inventory data 411B only for those in-store locations whose in-store inventory data 411B has not been confirmed. By limiting the amount of data requested in step 510, the inventory management process may be conducted faster and more efficiently. In step 515, the inventory database 105 may transmit a response back to the middleware server 110 indicating the in-store inventory data 411B and/or online inventory data 412B for the particular in-store locations and/or online inventory requested in step 510. The in-store inventory data 411B and/or online inventory data 412B transmitted from the inventory database 105 in step 515 may reflect the expected inventory that was intended for a particular in-store location or for fulfilling online orders. For example, the in-store inventory data 411B and online inventory data 412B may be populated based on the number, size, etc. of items ordered from a manufacturer or distributor. Alternatively, the inventory data 410B, which includes the in-store inventory data 411B and online inventory data 412B, stored in the inventory database 105 may reflect inventory information that has been confirmed or updated via store terminals 125 based on inventory that was actually received at in-store locations or at a facility for storing online inventory, and may reflect that date and time that the inventory data 410B was last confirmed or updated.

Upon receipt of the inventory data 410B from the inventory database 105 in step 515, the middleware server 120 may transmit the received inventory data 410B to the raffle database 115 to update the inventory data 410A stored in the raffle database 115. According to an example embodiment, the middleware server 120 may determine whether the inventory data 410B received from the inventory database 105 was updated or confirmed more recently than the inventory data 410A received from the raffle database 115 in step 505. If the inventory data 410B received from the inventory database 105 has been updated or confirmed more recently than the inventory data 410A received from the raffle database 115, the middleware server 120 may cause the raffle database 115 to update the inventory data 410A based on the inventory data 410B from the inventory database 105. By confirming and/or updating the inventory data 410A stored in the raffle database 115, the electronic raffle can be conducted using more accurate inventory information to reduce the likelihood of raffling items that are not available.

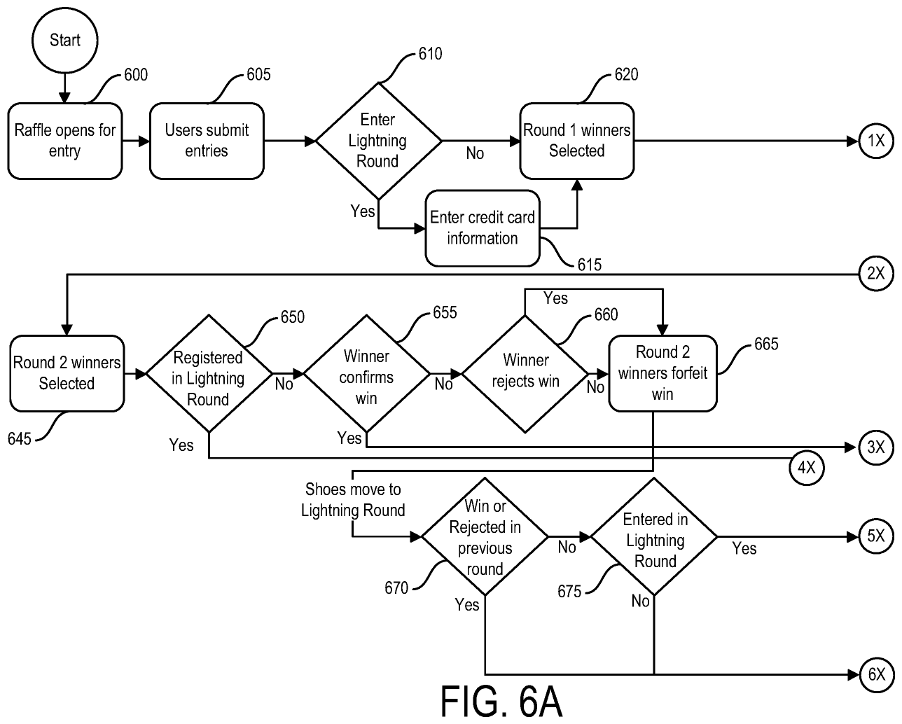

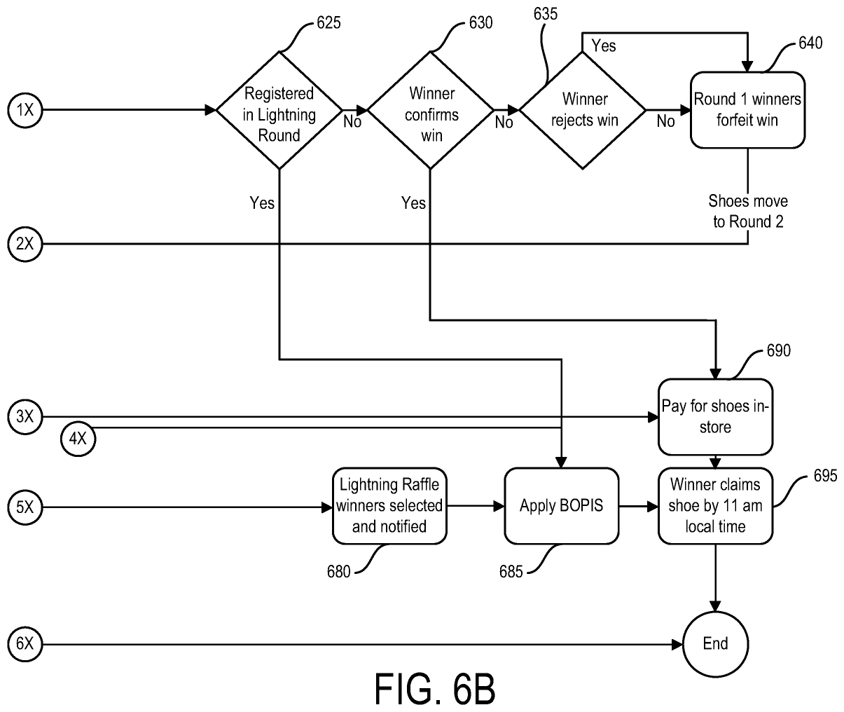

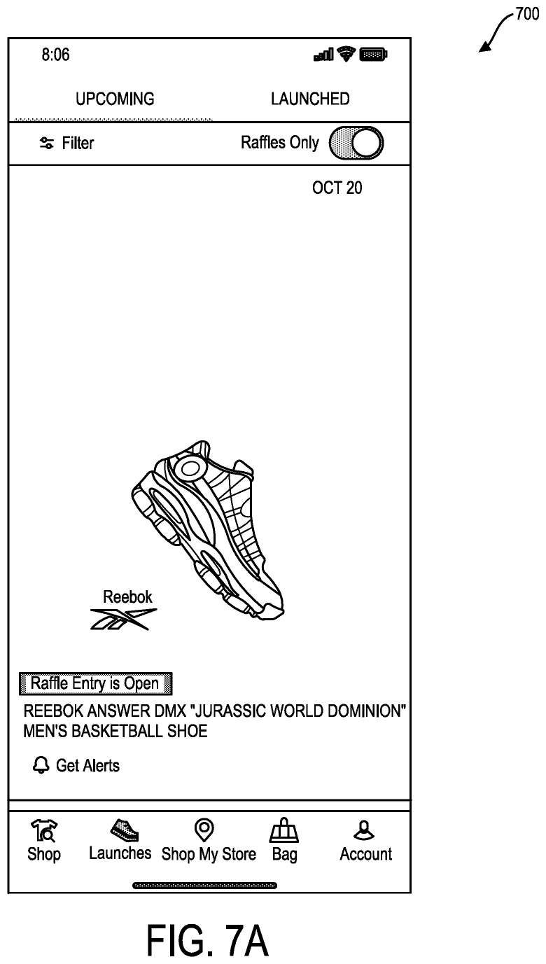

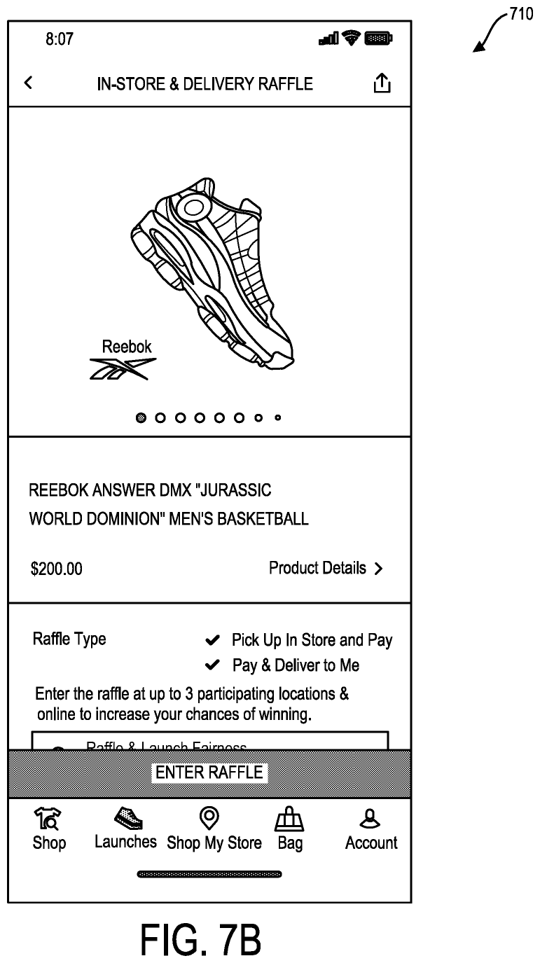

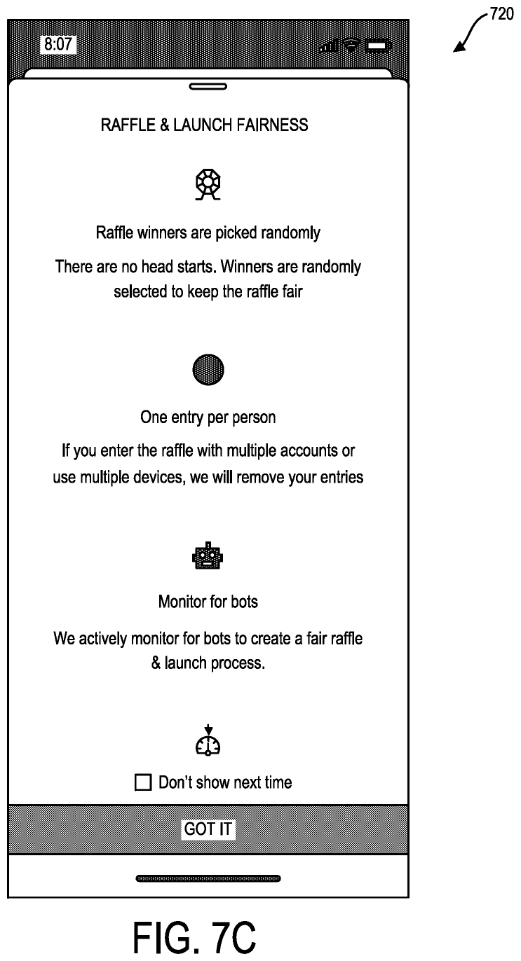

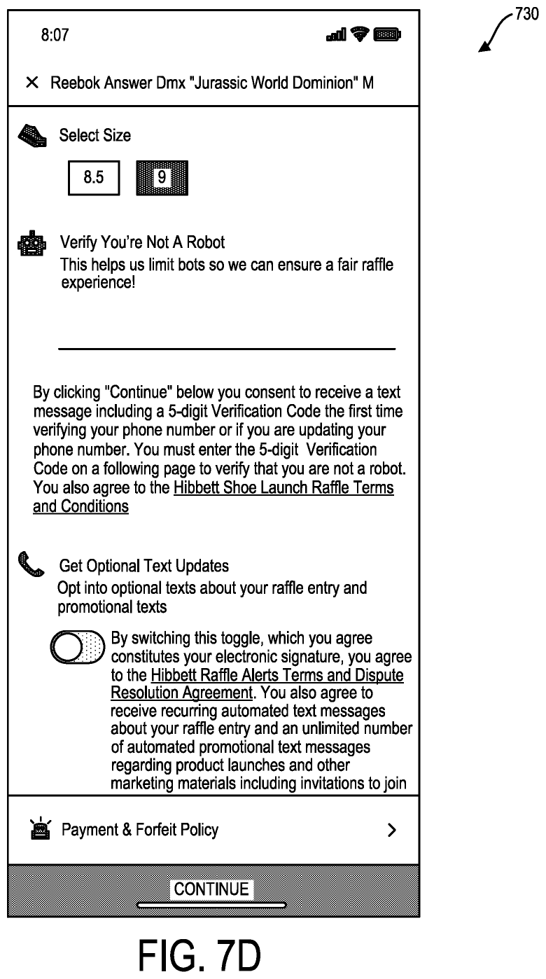

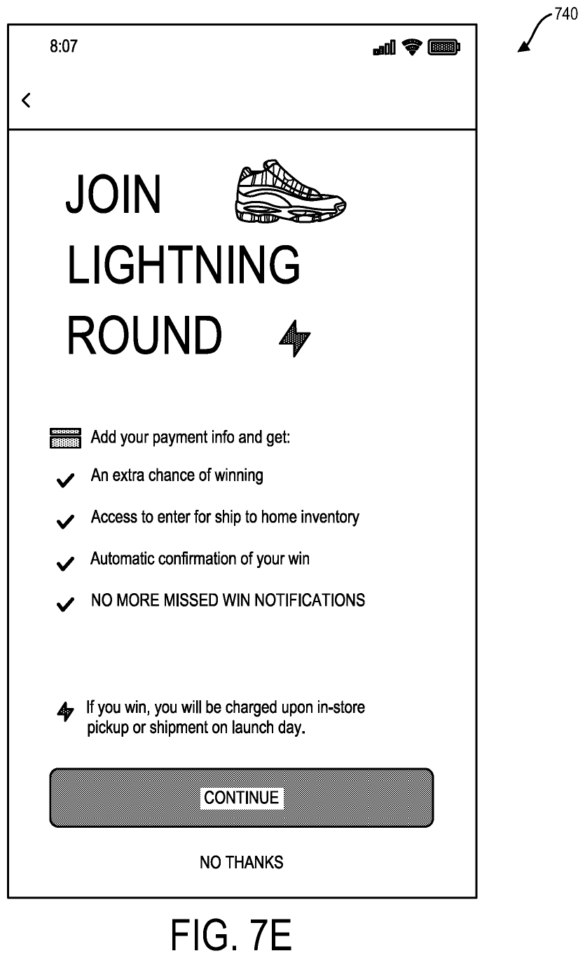

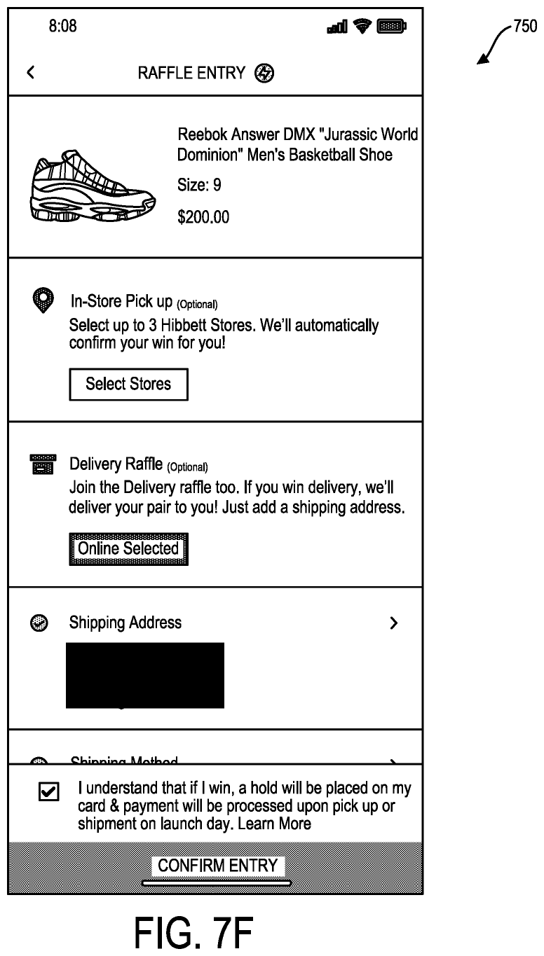

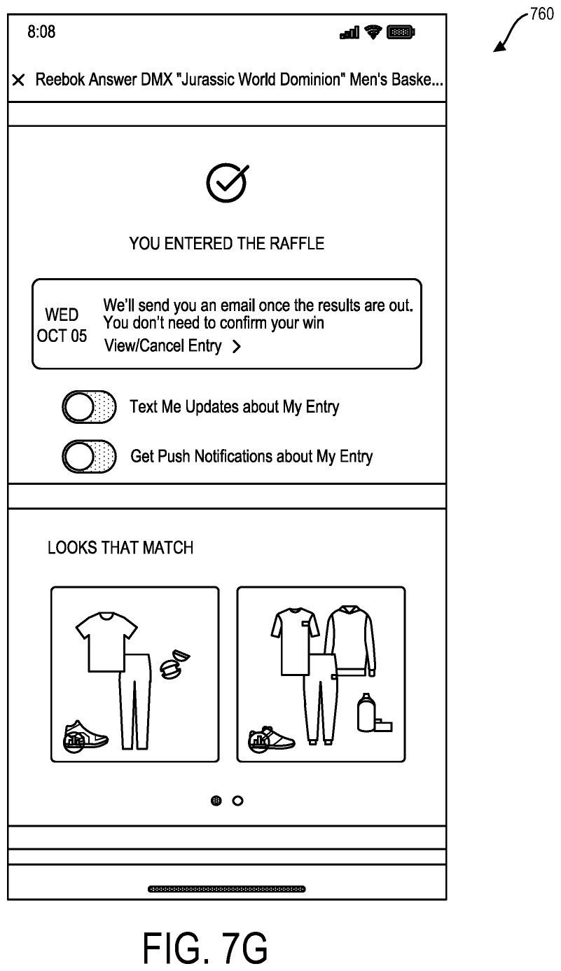

FIGS. 6A and 6B illustrate a flow chart of an electronic raffle using an inventory management system according to various example embodiments. FIGS. 7A-7G show example screen shots of various steps in the flowchart of FIGS. 6A and 6B. In step 600, the mobile application 110 may display a message on users' mobile devices indicating that the electronic raffle is open to receiving raffle entries. For example, FIG. 7A illustrates a screenshot 700 of the mobile application 110 showing products that are available for upcoming electronic raffles, and electronic raffles that have already launched. The mobile application 110 may indicate to the users the item or items that are included in the raffle, as well as the sizes, colors, models, and other information related to the items included in the raffle. For example, FIG. 7B illustrates a screenshot 710 that allows the user to view details about the product, as well as details related to the electronic raffle, such as pick-up and shipping options. When the user chooses to enter the raffle, the mobile application may display one or more notifications, such as those shown in screenshot 720 in FIG. 7C, which notify the user that the raffle winners are selected randomly, that each user is allowed only a single entry, and that the system actively monitors for automated computers or “bots” that may try to improperly submit multiple entries for a single user.

In step 605, the users may provide information via the mobile application 110 indicating that the user would like to enter the raffle, and including bibliographic information of the user (name, address, etc.), size information for raffled item(s), store raffle information indicating whether the raffle entry applies to in-store inventory and/or online inventory and one or more in-store locations at which the user would pick up any items purchased via the raffle of in-store inventory items, online raffle information indicating whether the raffle entry applies to online inventory, and lightning round information indicating whether the raffle entry applies to a lightning round of the electronic raffle. For example, FIG. 7D illustrates an example of a screenshot 730 of a user interface, which allows the user to select a size for the product the user is entering to win. The user may also input the user's mobile phone number in order to authenticate the user. Once the information is received from the user in step 605, the middleware server 120 may conduct an authentication process such as the authentication process described above in FIG. 3 to ensure that the raffle entry is legitimate, and that the user's entry does not violate any rules limiting the number of entries that may be submitted. If the raffle entry is determined to be legitimate and in compliance with electronic raffle rules, the mobile application 110 transmits the raffle entry to the raffle database 115.

FIG. 7E illustrates a screenshot 740 of an example user interface offering the user the ability to enter the lightning round, according to an example embodiment. As shown in the example screenshot 740 in FIG. 7E, the lightning round allows the user (1) an extra chance at winning if the user is not initially selected as a winner, (2) access to enter raffles for products in online inventory, and (3) automatic win confirmation, so the user does not have to confirm the win in order to avoid forfeiture.

In step 610, the middleware server 110 determines whether the lightning round information submitted with the raffle entry information indicates that the user is entering the lightning round. If the lightning round information indicates that the user is entering the lightning round, the middleware server 120 causes the mobile application 110 to request and receive payment information, such as credit card information, from the user. In step 615, the user enters the payment information via the mobile application 110, which is transmitted to the middleware server 120. For example, FIG. 7F illustrates a screenshot 750 of a user interface of the mobile application 110, which allows the user to specify pick-up and/or delivery options, as well as payment information for a lightning round entry. FIG. 7G illustrates a screenshot 760 of a user interface of the mobile application 110, notifying the user that the lightning round entry is confirmed, and indicating the date of the electronic raffle drawing. The middleware server 120 may transmit the payment information to a payment processing system (not shown) to facilitate payment if the raffle entry is selected as a winner. Prior to the beginning of the electronic raffle, the mobile application 110 may indicate to users that the raffle entries for the electronic raffle will be cutoff at a certain time, for example thirty minutes before the electronic raffle begins. At that time, or at a time just before the electronic raffle is to begin, the middleware server 120 may manage the inventory available for raffle, such as by performing the inventory management process described above in connection with FIG. 5.

Once the inventory data 410A of the raffle database 115 has been updated via the inventory management process, the middleware server 110 may randomly select one or more first round winning raffle entries from the raffle entries stored in the raffle database in step 620. The middleware server 120 may select the first round winning raffle entry based on information related to the item or items to be raffled, and the raffle entry information. For example, if the items to be raffled are a certain type of shoes, such as newly released basketball shoes that are often in high demand, the middleware server 120 may determine the sizes available, and the in-store locations at which each of the pairs of shoes are located, and select first round winning raffle entries having corresponding size information and store raffle information. In step 625, the middleware server 120 determines whether the first round winning raffle entry indicated participation in the lightning round, and if so, in step 685 applies a BOPIS payment process that completes payment using the user's payment information provided in step 615. If the middleware server 120 determines in step 625 that that the first round winning raffle entry did not indicate participation in the lightning round, the middleware server 120 determines in step 630 whether the user has confirmed the first round winning raffle entry using the mobile application 110, and if so, proceeds to step 690, in which the user pays for and picks up the raffle item (e.g., shoes) at a physical in-store location. In step 695, the middleware server 120 may determine whether the raffle item has been claimed by the user by a predetermined time (e.g., 11:00 AM). If the raffle item has not been claimed by the predetermined time, the item may be re-entered into the electronic raffle, in which case the process would return to step 620 or 680. If the first round winning raffle entry entered the lightning round or the first round winning raffle entry was confirmed by the winning user, the middleware server 120 may update the raffle database 115 and the inventory database 105 to indicate that the item or items won by the first round winning raffle entry are no longer available. If it is determined at step 630 that the user has not confirmed the first round winning raffle entry, the middleware server 120 determines at step 635 whether the user has rejected the first round winning raffle entry through the mobile application 110. If the user has rejected the first round winning raffle entry, or failed to confirm or reject the first round winning raffle entry within a predetermined time period, the middleware server 120 determines that the first round winning raffle entry has been forfeited at step 640, and proceeds to a second round.

In step 645, the middleware server 120 selects second round winning raffle entries similar to how first round wining raffle entries were selected in step 620, based on the size information and store raffle information contained in the raffle entries, and the size and location information of the remaining inventory that was not claimed in the first round of the electronic raffle. In step 650, the middleware server 120 determined whether the second round winning raffle entries indicate participation in the lightning round, and if so, in step 685 applies a BOPIS payment process that completes payment using the user's payment information provided in step 615. If the second round winning entry does not indicate participation in the lightning round, in step 655, the middleware server determines whether the user who submitted the second round winning raffle entry has confirmed the second winning raffle entry via the mobile application 110, and if so proceeds to step 690, in which the user pays for and picks up the raffle item (e.g., shoes) at a physical in-store location. In step 695, the middleware server 120 may determine whether the raffle item has been claimed by the user by a predetermined time (e.g., 11:00 AM). If the raffle item has not been claimed by the predetermined time, the item may be re-entered into the electronic raffle, in which case the process would return to step 620 or 680. If the second round winning raffle entry entered the lightning round or the second round winning raffle entry was confirmed by the winning user, the middleware server 120 may update the raffle database 115 and the inventory database 105 to indicate that the item or items won by the second round winning raffle entry are no longer available. If it is determined at step 655 that the user has not confirmed the second round winning raffle entry, the middleware server 120 determines at step 660 whether the user has rejected the second round winning raffle entry through the mobile application 110. If the user has rejected the second round winning raffle entry, or failed to confirm or reject the second round winning raffle entry within a predetermined time period, the middleware server 120 determines that the second round winning raffle entry has been forfeited at step 665, and proceeds to the lightning round.

In step 670, the middleware server 120 selects a lightning round winning raffle entry and determines whether the selected lightning round winning raffle entry has won or been rejected in the first or second rounds. If so, the middleware server selects another lightning round winning raffle entry, and continues selecting lightning round winning raffle entries until an entry that did not win or was not rejected in the first or second round. If no raffle entries that have not previously won or been rejected remain in the raffle database 115, the process ends. If the lighting round winning raffle entry has not been rejected or previously selected as a winning raffle entry, the middleware server confirms in step 675 that the selected lightning round winning raffle entry has indicated participation in the lightning round. If the selected lightning round winning raffle entry has not indicated participation in the lightning round, additional raffle entries are selected until there are no remaining raffle entries, at which point the process ends. If in step 675 the lightning round winning raffle entry does indicate participation in the lightning round, the winning user is notified in step 680 via the mobile application 110, and in step 685 a BOPIS payment process is initiated that completes payment using the user's payment information provided in step 615. According to an example embodiment, in steps 670 and 675, the middleware server 120 may filter remaining raffle entries to remove entries that have previously won or been rejected, and those entries that have not indicated participation in the lightning round, before selecting the lightning round winning raffle entry in step 680. After the BOPIS payment process has been completed in step 685, the winner may pick up the raffled item(s) at an in-store location in step 695. If the items are not picked up by a specified time, the items may be re-entered into the raffle database 115 for a future electronic raffle. Alternatively, for online raffle items, rather than the user picking up the items at an in-store location, the raffled items are shipped to the user from online inventory according to the shipping information provided by the user when submitting the raffle entry.

Although the exemplary embodiments discussed above have been described in the context of automotive or industrial applications, the exemplary embodiments are not limited to such applications and can apply to many other applications.

Many different embodiments have been disclosed herein, in connection with the above description and the drawings. It will be understood that it would be unduly repetitious to literally describe and illustrate every combination and subcombination of these embodiments. Accordingly, all embodiments can be combined in any way and/or combination, and the present specification, including the drawings, shall be construed to constitute a complete written description of all combinations and sub combinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. An inventory management system for managing inventory for an electronic raffle, the inventory management system comprising:
an inventory database configured to store inventory data for one or more items to be sold via the electronic raffle, wherein said inventory data comprises in-store inventory data relating to said one or more items to be picked up in-store by a winner of said electronic raffle, and online inventory data relating to online inventory of said one or more items to be shipped to a winner of said electronic raffle;
a mobile application configured to execute on a mobile device and generate a raffle entry for said one or more items, wherein said raffle entry includes bibliographic information of a user, size information for said one or more items, store raffle information indicating whether the raffle entry applies to in-store inventory and identifying one more stores at which said one or more items may be picked up, online raffle information indicating whether the raffle entry applies to online inventory, and lightning round information indicating whether the raffle entry applies to a lightning round of the electronic raffle;
a raffle database configured to store one or more raffle entries for said one or more items, and said inventory data;
a middleware server configured to determine whether the in-store inventory data stored in the raffle database has been confirmed, and in response to determining that the in-store inventory data stored in the raffle database has not been confirmed, obtaining updated in-store inventory data from the inventory database, and updating the in-store inventory data stored in the raffle database based on the updated in-store inventory data obtained from the inventory database;
wherein the middleware server is configured to select a first round winning raffle entry from said one or more raffle entries stored in the raffle database, transmit a notification to the mobile device associated with the first round winning raffle entry, and initiate a payment process upon determining that the first round winning raffle entry applies to the lightning round.

2. The inventory management system of claim 1, wherein upon determining that the first round winning raffle entry does not apply to the lightning round, and is rejected or not confirmed, the middleware server is configured to select a second round winning raffle entry from said one or more raffle entries stored in the raffle database, transmit a notification to the mobile application of the mobile device associated with the second round winning raffle entry, and initiate a payment process upon determining that the second round winning raffle entry applies to the lightning round.

3. The inventory management system of claim 2, wherein upon determining that the second winning raffle entry does not apply to the lightning round, and is rejected or not confirmed, the middleware server is configured to select a lightning round winning raffle entry from said one or more raffle entries stored in the raffle database having lightning round information indicating that the one or more raffle entries applies to the lightning round, transmit a notification to the mobile application of the mobile device associated with the lightning round winning raffle entry, and initiate a payment process.

4. The inventory management system of claim 1, wherein the middleware server selects the first round winning raffle entry based on a comparison of the size information included in the raffle entry and size information of said one or more items to be sold via the electronic raffle.

5. The inventory management system of claim 1, wherein the middleware server selects the first round winning raffle entry based on a comparison of store raffle information identifying one or more stores at which said one or more items may be picked up, and in-store inventory data indicating said one or more items to be sold via the electronic raffle is located at said one or more stores identified by the store raffle information.

6. The inventory management system of claim 5, wherein the notification transmitted by the middleware server to the mobile application includes a location from which said user can pick up said one or more items.

7. The inventory management system of claim 1, wherein the middleware server selects the first round winning raffle entry based on a comparison of online raffle information indicating that a raffle entry applies to online inventory, and online inventory data indicating that said one or more items to be sold via the electronic raffle are in online inventory.

8. The inventory management system of claim 7, wherein the middleware server determines whether the lightning round information indicates that the raffle entry applies to the lightning round, and selects the first round winning raffle entry of said one more items in online inventory based on determining that the winning raffle entry applies to the lightning round.

9. The inventory management system of claim 7, wherein the middleware server is configured to generate a shipping order to ship said one or more items in online inventory to the user based on said bibliographic information of the user.

10. The inventory management system of claim 2, wherein upon determining that the first round winning raffle entry is rejected or not confirmed, the middleware server is configured to remove the first round winning raffle entry from the raffle database before selecting the second round winning raffle entry.

11. The inventory management system of claim 1, wherein the in-store inventory data stored in the inventory database indicates an expected number of said one or more items available at a particular store; and
wherein the raffle database is configured to receive confirmation of an actual number of said one or more items available at the particular store, and the middleware server is configured to update the inventory data stored in the raffle database based on said confirmation.

12. The inventory management system of claim 1, wherein the inventory data stored in the inventory database and the raffle database are updated based on the selection of the first round winning raffle entry.

13. The inventory management system of claim 1, wherein said raffle entry includes a phone number and device ID associated with the mobile device, and an email address associated with the raffle entry;
wherein said middleware server is configured to validate said email address and said phone number, determine whether any other raffle entries for said one or more items have been received, reject said raffle entry if the middleware server is unable to validate said email address or said phone number, and reject said raffle entry if said phone number, device ID, or email address is associated with said any other raffle entries.

14. A method of managing inventory for an electronic raffle using an inventory management system, the method comprising:
storing inventory data for one or more items to be sold via the electronic raffle in an inventory database of the management system, wherein said inventory data comprises in-store inventory data relating to said one or more items to be picked up in-store by a winner of said electronic raffle, and online inventory data relating to online inventory of said one or more items to be shipped to a winner of said electronic raffle;
generating a raffle entry for said one or more items, wherein said raffle entry includes bibliographic information of a user, size information for said one or more items, store raffle information indicating whether the raffle entry applies to in-store inventory and identifying one more stores at which said one or more items may be picked up, online raffle information indicating whether the raffle entry applies to online inventory, and lightning round information indicating whether the raffle entry applies to a lightning round of the electronic raffle;
storing said inventory data and one or more raffle entries for said one or more items in a raffle database;
determining whether the in-store inventory data stored in the raffle database has been confirmed, and in response to determining that the in-store inventory data stored in the raffle database has not been confirmed, obtaining updated in-store inventory data from the inventory database, and updating the in-store inventory data stored in the raffle database based on the updated in-store inventory data obtained from the inventory database;
selecting a first round winning raffle entry from said one or more raffle entries stored in the raffle database;
transmitting a notification to a mobile device associated with the first round winning raffle entry; and
initiating a payment process upon determining that the first round winning raffle entry applies to the lightning round.

15. The method of claim 14, further comprising:
determining that the first round winning raffle entry does not apply to the lightning round, and is rejected or not confirmed;
selecting a second round winning raffle entry from said one or more raffle entries stored in the raffle database;
transmitting a notification to the mobile application of a mobile device associated with the second round winning raffle entry; and
initiating a payment process upon determining that the second round winning raffle entry applies to the lightning round.

16. The method of claim 15, further comprising:
determining that the second winning raffle entry does not apply to the lightning round, and is rejected or not confirmed;
selecting a lightning round winning raffle entry from said one or more raffle entries stored in the raffle database having lightning round information indicating that the one or more raffle entries applies to the lightning round;
transmitting a notification to the mobile application of the mobile device associated with the lightning round winning raffle entry; and
initiating a payment process.

17. The method of claim 14, wherein the first round winning raffle entry is selected based on a comparison of the size information included in the raffle entry and size information of said one or more items to be sold via the electronic raffle.

18. The method of claim 14, wherein the first round winning raffle entry is selected based on a comparison of store raffle information identifying one or more stores at which said one or more items may be picked up, and in-store inventory data indicating said one or more items to be sold via the electronic raffle is located at said one or more stores identified by the store raffle information.

19. The method of claim 14, wherein the in-store inventory data stored in the inventory database indicates an expected number of said one or more items available at a particular store; and
wherein said method further comprises receiving, at the raffle database, confirmation of an actual number of said one or more items available at the particular store, and updating the inventory data stored in the raffle database based on said confirmation.

20. The method of claim 14, wherein said raffle entry includes a phone number and device ID associated with a mobile device associated with the user, and an email address associated with the raffle entry; said method further comprising:
validating said email address and said phone number;
determining whether any other raffle entries for said one or more items have been received;
rejecting said raffle entry if the middleware server is unable to validate said email address or said phone number; and
rejecting said raffle entry if said phone number, device ID, or email address is associated with said any other raffle entries.
